(19) United States
(12) Patent Application Publication
(10) Pub. No.: US 2022/0216765 A1
(43) Pub. Date: Jul. 7, 2022

(54) DRIVE UNIT FOR ELECTRIC VEHICLE

(71) Applicant: TOYOTA JIDOSHA KABUSHIKI KAISHA, Toyota-shi (JP)

(72) Inventors: Masashi IKEMURA, Toyota-shi (JP); Yukihiko IDESHIO, Nisshin-shi (JP); Tetsuya YAMAGUCHI, Anjo-shi (JP)

(73) Assignee: TOYOTA JIDOSHA KABUSHIKI KAISHA, Toyota-shi (JP)

(21) Appl. No.: 17/564,295

(22) Filed: Dec. 29, 2021

(30) Foreign Application Priority Data
Jan. 7, 2021 (JP) 2021-001629

(51) Int. Cl. H02K 7/00; B60K 1/00; B60K 17/02; F16H 45/02

(52) U.S. Cl. CPC H02K 7/006; B60K 1/00; F16H 2045/002; F16H 45/02; B60K 17/02

(57) ABSTRACT

A motor generator including a rotor and a motor output shaft that rotates integrally with the rotor, a connecting shaft capable of rotating coaxially with the motor output shaft, a hydraulic clutch interposed between the rotor and the connecting shaft, the hydraulic clutch switching transmission and non-transmission of torque between the rotor and the connecting shaft, and an auxiliary to be driven by rotation of the input shaft are provided. The input shaft of the auxiliary is mechanically linked with the connecting shaft.

### CROSS-REFERENCE TO RELATED APPLICATION

This application claims priority to Japanese Patent Application No. 2021-001629 filed on Jan. 7, 2021, incorporated herein by reference in its entirety.

### BACKGROUND

### 1. Technical Field

This present disclosure relates to a drive unit for an electric vehicle.

### 2. Description of Related Art

In the electric vehicle disclosed in Japanese Unexamined Patent Application Publication No. 2010-252584, as a drive source for the vehicle, an originally mounted internal combustion engine is removed and a motor is installed instead of the internal combustion engine.

### SUMMARY

As in JP 2010-252584 A, where a motor is used in substitution for an internal combustion engine, a motor used in another vehicle may be reused. Here, among hybrid vehicles using an internal combustion engine and a motor as drive sources, there are those of a type in which an output shaft of an internal combustion engine is connected to an output shaft of a motor via a clutch. Then, in a motor in this type of hybrid vehicle, a clutch is provided as an assembly integral with the motor. Where such motor is reused in an electric vehicle, the clutch is mounted in the electric vehicle together with the motor. However, when the motor and the clutch are mounted in the electric vehicle, the clutch, which has a function that transmits torque of the motor to an internal combustion engine in the hybrid vehicle, is an unused component that does not function in any way when mounted in the electric vehicle because the internal combustion engine has been disconnected.

A drive unit for an electric vehicle for solving the above problem includes: a motor including a tubular rotor, a stator located radially outward of the rotor as viewed from a center axis of the rotor, and an output shaft that rotates integrally with the rotor and that transmits a drive force of the rotor to a drive wheel; a connecting shaft capable of rotating coaxially with the output shaft; a hydraulic clutch interposed between the rotor and the connecting shaft, the hydraulic clutch switching between transmission and non-transmission of torque between the rotor and the connecting shaft; and an auxiliary including an input shaft, the auxiliary being driven by rotation of the input shaft. The input shaft is mechanically linked with the connecting shaft such that torque from the rotor can be input to the input shaft.

In the above configuration, the motor is connected to the auxiliary via the clutch and the connecting shaft. Therefore, the auxiliary is driven by motive power of the motor. In this way, the above configuration enables using the clutch integrated with the motor, as a component that transmits motive power of the motor to the auxiliary. Therefore, it is possible to effectively use reused components without any waste.

The drive unit for an electric vehicle may include: a hydraulic pump that supplies a hydraulic fluid to the hydraulic clutch; and a control device that controls hydraulic pressure of the hydraulic fluid supplied from the hydraulic pump to the hydraulic clutch.

With the above configuration, it is possible to make the hydraulic clutch operate via the control device irrespective operation of the motor to switch between transmission and non-transmission of torque. Accordingly, it is possible to freely drive or stop the auxiliary as necessary.

The drive unit for an electric vehicle may include, where a first direction is a direction in which the connecting shaft is located as viewed from the motor, of directions along the center axis of the rotor, a case that receives the motor, the connecting shaft and the hydraulic clutch, and an attachment that is located in the first direction as viewed from the motor, and that is attached to the case. The attachment may include a plurality of bolt holes. The auxiliary may be connected to the attachment via a bolt inserted in a bolt hole selected from the plurality of bolt holes.

As in the above configuration, use of the attachment enables disposing any of auxiliaries at a proper position without changing a structure for attachment of the auxiliary, the structure being inside the case, for the auxiliary. In other words, the case can be used in common. Also, the attachment includes the plurality of bolt holes. Therefore, any of auxiliaries can be disposed at a proper position without changing the attachment for the auxiliary, by selecting bolt holes at suitable positions from among the plurality of the bolt holes according to a shape and dimensions of the auxiliary to be attached to the attachment. In other words, the attachment can be used in common.

In the drive unit for an electric vehicle, the auxiliary may be located in the first direction as viewed from the attachment and be located outside the case, the connecting shaft may extend through the attachment, the input shaft may be disposed in parallel with the connecting shaft, and an endless power transmission component located outside the case and looped around the input shaft and the connecting shaft may be provided.

Where the linking structure using the endless power transmission component is used as in the above configuration, as long as the input shaft is disposed in parallel with the connecting shaft, the input shaft and the connecting shaft can be linked in such a manner as to be capable of rotating integrally. In other words, it is possible to freely change the disposition of the auxiliary as long as the condition that the input shaft is disposed in parallel with the connecting shaft is met. Therefore, the degree of flexibility in disposition of the auxiliary is enhanced. Also, since the auxiliary is located outside the case, work of detaching and attaching the auxiliary can easily be performed. Therefore, it does not take much trouble to, for example, replace the auxiliary or change the disposition of the auxiliary.

In the drive unit for an electric vehicle, the attachment may include a through-hole through which the connecting shaft extends; and a bearing that rotatably supports the connecting shaft is located inside the through-hole. In this configuration, there is no need to separately provide a structure that supports the bearing.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of an electric vehicle;

FIG. 2 is a schematic diagram illustrating manners of connections in a drive mechanism in a case;

FIG. 3 is an enlarged view of region 3 in FIG. 2; and

FIG. 4 is a plan view of an attachment.

### DETAILED DESCRIPTION OF EMBODIMENTS

An embodiment of an electric vehicle to which a drive unit for an electric vehicle is applied will be described with reference to the drawings.

Schematic Configuration of Electric Vehicle

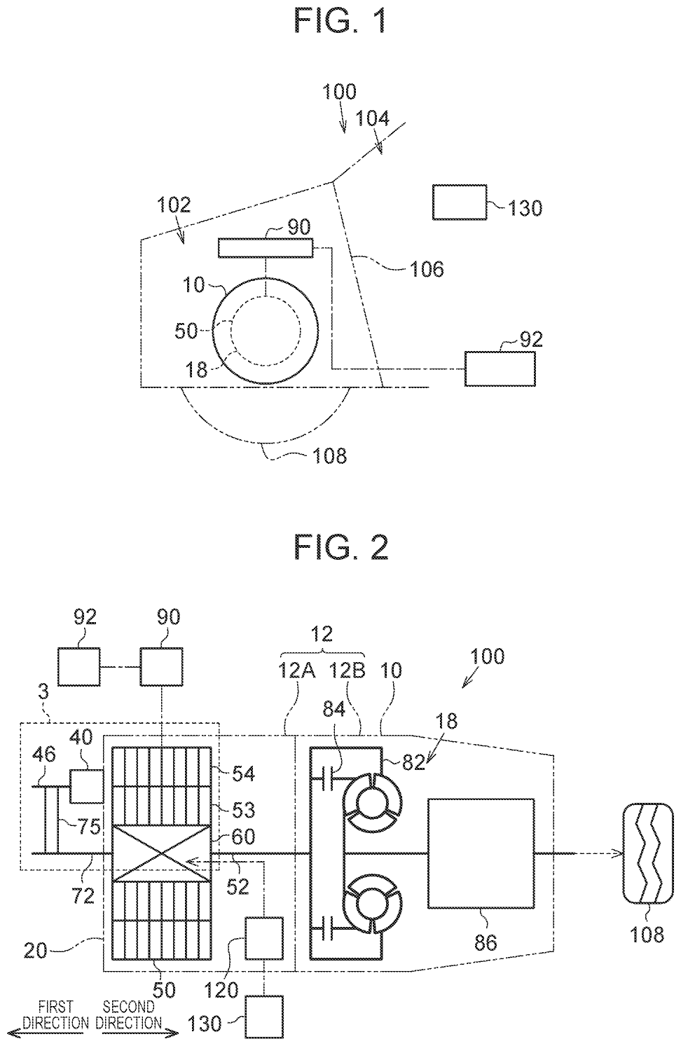

As illustrated in FIG. 1, an electric vehicle 100 includes a motor compartment 102, a dash panel 106 and a vehicle cabin 104. The motor compartment 102 is a space defined in a part on the front side of the electric vehicle 100. The dash panel 106 is a wall portion that defines a rear end of the motor compartment 102. The vehicle cabin 104 is a space defined on the opposite side of the dash panel 106 from the motor compartment 102. The vehicle cabin 104 provides a riding space for occupants.

As illustrated in FIG. 2, the electric vehicle 100 includes a case 10, an attachment 20, a drive mechanism 18 and drive wheels 108. As illustrated in FIG. 1, the case 10 is located inside the motor compartment 102. The case 10 is made of, for example, an aluminum alloy. As illustrated in FIG. 2, the case 10 includes a case body 12. Furthermore, the case body 12 includes a first case body 12A and a second case body 12B. The first case body 12A has a tubular shape overall. The second case body 12B has a bottomed tubular shape overall. The first case body 12A and the second case body 12B are integrally coupled with one opening of the first case body 12A and an opening of the second case body 12B butted against each other. The attachment 20 occludes an opening, on the side opposite to the opening to which the second case body 12B is coupled, of the first case body 12A. As a result, a component resulting from integration of the case body 12 and the attachment 20 has a columnar shape with a space defined inside, overall. In the below, when the above two parts forming the case body 12 are individually described, the two parts are respectively referred to as the first case body 12A and the second case body 12B in the description, and when the two parts are collectively described, the two parts are collectively referred to as the case body 12.

The drive mechanism 18 is mainly located inside the case body 12. The drive mechanism 18 includes a connecting shaft 72, a hydraulic clutch 60, a motor generator 50, a torque converter 82 and a transmission mechanism 86. In a direction along a center axis of the case body 12, the above components are basically arranged in the order mentioned above from the attachment 20 toward a bottom part of the second case body 12B. The hydraulic clutch 60 and the motor generator 50 alone are located at respective positions that are identical to each other in a direction along the center axis of the case body 12. A part of the connecting shaft 72, the hydraulic clutch 60 and the motor generator 50 are located inside the first case body 12A. The connecting shaft 72 extends through the attachment 20 and is partly located outside the case body 12. The torque converter 82 and a major part of the transmission mechanism 86 are located inside the second case body 12B. The transmission mechanism 86 extends through the bottom part of the second case body 12B and is partly located outside the case body 12.

Schematic manners of connections of the components of the drive mechanism 18 and basic functions of the components are as follows. The connecting shaft 72 is connected to an output shaft (hereinafter, referred to as a motor output shaft) 52 of the motor generator 50 via the hydraulic clutch 60. The hydraulic clutch 60 switches between transmission and non-transmission of torque between the connecting shaft 72 and the motor output shaft 52. The motor generator 50 is an electric power generator motor and serves as a drive source of the electric vehicle 100. The motor output shaft 52 is connected to an input shaft of the torque converter 82. The torque converter 82 is a fluid coupling. The torque converter 82 switches between transmission and non-transmission of torque between the input shaft and an output shaft of the torque converter 82. The torque converter 82 includes a lock-up clutch 84. The lock-up clutch 84 switches between mechanical connection and disconnection between the input shaft and the output shaft of the torque converter 82. The output shaft of the torque converter 82 is connected to an input shaft of the transmission mechanism 86. The transmission mechanism 86 changes a gear ratio, which is a difference in rotation speed between the input shaft and an output shaft, in multiple stages. The transmission mechanism 86 outputs torque according to the gear ratio. The output shaft of the transmission mechanism 86 extends to the outside of the case body 12 through the case body 12. The output shaft of the transmission mechanism 86 is connected to the drive wheels 108 via a differential gear. The differential gear allows occurrence of a difference in rotation speed between the left and right drive wheels 108. In FIG. 2, illustration of the differential gear is omitted.

The electric vehicle 100 includes an inverter 90 and a battery 92. The battery 92 is electrically connected to the motor generator 50 via the inverter 90. The battery 92 supplies electric power to the motor generator 50 and stores electric power supplied from the motor generator 50. As illustrated in FIG. 1, the battery 92 is located under a floor of the vehicle cabin 104. The inverter 90 performs DC-AC conversion between the battery 92 and the motor generator 50. The inverter 90 is located inside the motor compartment 102.

Detailed Structure of Vicinity of Motor Generator

In the drive mechanism 18, the motor generator 50, the hydraulic clutch 60 and the connecting shaft 72 are integrally included in an assembly. In the below, structures of mutual connection of these components will be described.

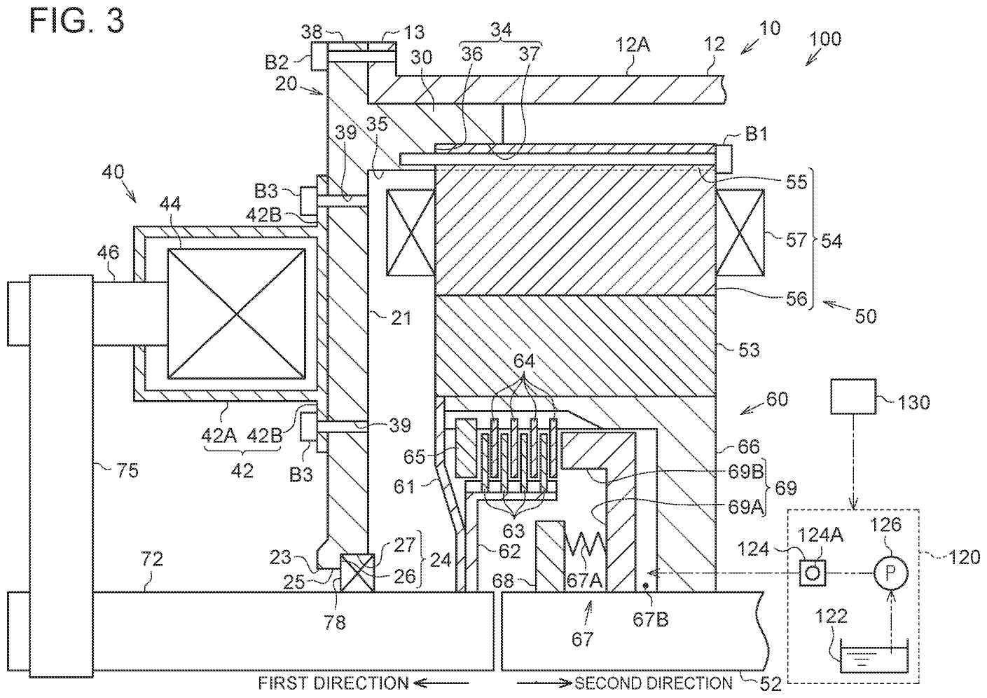

As illustrated in FIG. 3, the hydraulic clutch 60 includes a hub 62, a drum 66, a plurality of first friction plates 63, a plurality of second friction plates 64, an end plate 65, a moving mechanism 67 and a lid body 61. The hub 62 has a bottomed tubular shape overall. The connecting shaft 72 having a rod-like shape extends through a bottomed part of the hub 62. A center axis of the hub 62 and a center axis of the connecting shaft 72 are coincident with each other. The hub 62 and the connecting shaft 72 rotate integrally. Inside the hub 62, a distal end of the connecting shaft 72 does not reach an opening of the hub 62.

The plurality of first friction plates 63 are located on an outer circumferential surface of the hub 62. The plurality of first friction plates 63 are arranged in a direction along the center axis of the hub 62. The first friction plates 63 each have an annular shape. The first friction plates 63 each project radially from the outer circumferential surface of the hub 62. The first friction plates 63 are movable in directions along the center axis of the hub 62 relative to the hub 62.

The drum 66 is located on the radially outer side relative to the hub 62 overall as viewed from the center axis of the hub 62. The drum 66 has a bottomed tubular shape overall. The drum 66 has an inner diameter that is larger than an outer diameter of the hub 62. The drum 66 receives the hub 62. An opening of the drum 66 faces in a direction opposite to a direction in which the opening of the hub 62 faces. A center axis of the drum 66 and the center axis of the hub 62 are coincident with each other. The motor output shaft 52 having a rod-like shape extends through a bottomed part of the drum 66. The center axis of the drum 66 and a center axis of the motor output shaft 52 are coincident with each other. The drum 66 and the motor output shaft 52 rotate integrally. In other words, the motor output shaft 52 is capable of rotating coaxially with the connecting shaft 72. The motor output shaft 52 extends up to the inside of the hub 62 and faces the connecting shaft 72. In other words, the motor output shaft 52 and the connecting shaft 72 are adjacent to each other in a direction along the center axes of the motor output shaft 52 and the connecting shaft 72. In the below, of directions along the center axes of the connecting shaft 72 and the motor output shaft 52, a direction in which the connecting shaft 72 is located as viewed from the motor output shaft 52 is referred to as “first direction” and a direction in which the motor output shaft 52 is located as viewed from the connecting shaft 72 is referred to as “second direction”.

The lid body 61 closes the opening of the drum 66. The lid body 61 extends through the connecting shaft 72. The plurality of second friction plates 64 are located on an inner circumferential surface of the drum 66. The plurality of second friction plates 64 are arranged in a direction along the center axis of the drum 66. The second friction plates 64 each have an annular shape. The second friction plates 64 project radially from the inner circumferential surface of the drum 66. The second friction plates 64 are disposed such that the first friction plates 63 and the second friction plates 64 are alternately disposed. The second friction plates 64 face the adjacent first friction plates 63, respectively. The second friction plates 64 are movable relative to the drum 66 in directions along the center axis of the drum 66. In the below, a group of friction plates formed by the plurality of first friction plates 63 and the plurality of second friction plates 64 is referred to as “plate group”.

The end plate 65 is located on the inner circumferential surface of the drum 66. The end plate 65 has an annular shape. The end plate 65 projects radially from the inner circumferential surface of the drum 66. The end plate 65 is located in the first direction relative to the plate group. The end plate 65 faces a friction plate located at an end in the first direction of the plate group. The end plate 65 is immovable relative to the drum 66 in the directions along the center axis of the drum 66.

The moving mechanism 67 includes a fixed plate 68, a piston 69, a plurality of springs 67A, and a fluid chamber 67B. The fixed plate 68 is located inside the drum 66. The fixed plate 68 has an annular shape. The fixed plate 68 is attached to the motor output shaft 52 via a hole in a center of the fixed plate 68. In other words, the fixed plate 68 projects radially from the motor output shaft 52. The fixed plate 68 is immovable relative to the motor output shaft 52 in the directions along the center axis of the motor output shaft 52.

The piston 69 is located between the fixed plate 68 and the bottom part of the drum 66 inside the drum 66. The piston 69 includes a piston body 69A and a contact portion 69B. The piston body 69A has an annular shape. The piston body 69A is attached to the motor output shaft 52 via a hole in the center of the piston body 69A. In other words, the piston body 69A projects radially from the motor output shaft 52. The piston body 69A is immovable relative to the motor output shaft 52 in the directions along the center axis of the motor output shaft 52.

The contact portion 69B projects in the first direction from the piston body 69A. The contact portion 69B is located at a part on the outer circumferential side of the piston body 69A. The contact portion 69B continuously extends over an entire circumference of the piston body 69A. A projecting end of the contact portion 69B faces a friction plate located at an end in the second direction of the plate group.

The plurality of springs 67A are attached to the piston body 69A and the fixed plate 68. The plurality of springs 67A are circumferentially arranged at equal intervals. The plurality of springs 67A bias the piston 69 in the second direction, which is a direction away from the plate group.

The fluid chamber 67B is a space defined between the piston body 69A and the bottom part of the drum 66. In other words, the fluid chamber 67B is located on the opposite side of the piston 69 from the plurality of springs 67A and in the second direction relative to the piston 69. The fluid chamber 67B is supplied with a hydraulic fluid from a later-described hydraulic pressure adjustment mechanism 120. According to a relationship in magnitude between hydraulic pressure in the fluid chamber 67B and a biasing force of the plurality of springs 67A, the piston 69 moves close to or away from the plate group and the end plate 65. As a result, an operating state of the hydraulic clutch 60 changes.

In other words, where the hydraulic pressure in the fluid chamber 67B is larger than the biasing force of the plurality of springs 67A, the piston 69 moves close to the plate group and the end plate 65. In this case, the piston 69 sandwiches the plate group jointly with the end plate 65. As a result, the first friction plates 63 and the second friction plates 64 adjacent to one another come into contact with one another. In other words, the hydraulic clutch 60 is engaged. In this case, torque is transmitted between the hub 62 and the drum 66. On the other hand, where the hydraulic pressure in the fluid chamber 67B is smaller than the biasing force of the plurality of springs 67A, the piston 69 moves away from the plate group and the end plate 65. In this case, the piston 69 releases the plate group jointly with the end plate 65. As a result, the first friction plates 63 and the second friction plates 64 are disposed at respective positions that are spaced from one another. In other words, the hydraulic clutch 60 is disengaged. In this case, no torque is transmitted between the hub 62 and the drum 66.

The hydraulic clutch 60 described above is incorporated inside the motor generator 50. The motor generator 50 includes a rotor 53 and a stator 54 in addition to the above-described motor output shaft 52.

The rotor 53 is located radially outward of the drum 66 as viewed from the center axis of the drum 66. The rotor 53 has a tubular shape. The rotor 53 has an inner diameter that is substantially the same as an outer diameter of the drum 66. The rotor 53 surrounds the drum 66. An inner circumferential surface of the rotor 53 is fixed to the drum 66. The rotor 53 is connected to the motor output shaft 52 via the drum 66. The rotor 53 rotates integrally with the motor output shaft 52.

The stator 54 includes a stator body 55, a plurality of teeth 56 and a coil 57. The stator body 55 is located radially outward of the rotor 53 as viewed from a center axis of the rotor 53. The stator body 55 has a tubular shape. The stator body 55 has an inner diameter that is larger than an outer diameter of the rotor 53. The stator body 55 surrounds the rotor 53. A center axis of the stator body 55 is coincident with the center axis of the rotor 53.

The plurality of teeth 56 project from an inner circumferential surface of the stator body 55. The plurality of teeth 56 are circumferentially arranged at equal intervals. There is space between projecting ends of the plurality of teeth 56 and an outer circumferential surface of the rotor 53. In FIG. 3, illustration of the space is omitted. The coil 57 is wound on the plurality of teeth 56. The coil 57 is partially located outward of opposite end surfaces of the stator body 55.

Attachment

The motor generator 50 is connected to the case body 12 via the attachment 20. As described above, the attachment 20 is a component that occludes an opening of the first case body 12A. In the below, first, a configuration of the attachment 20 will be described, and then, a structure of attachment of the motor generator 50 via the attachment 20 will be described.

The attachment 20 includes an attachment body 21, a projection portion 30, a plurality of bolt holes 39 and a plurality of attaching portions 38. The attachment 20 is made of, for example, an aluminum alloy.

The attachment body 21 has a round plate-like shape. The attachment body 21 includes a through-hole 23 that opens in each of opposite surfaces of the attachment body 21. An inner surface of the through-hole 23 includes a body small diameter portion 25, and a body large diameter portion 27 that is larger in diameter than the body small diameter portion 25. The body small diameter portion 25 and the body large diameter portion 27 are adjacent to each other. In other words, the inner surface of the through-hole 23 has a stepped shape. Center axes of the body small diameter portion 25 and the body large diameter portion 27 are coincident with each other. The diameter of the body small diameter portion 25 is larger than a diameter of the connecting shaft 72. The diameter of the body large diameter portion 27 is substantially equal to an outer diameter of a later-described bearing 78. The body large diameter portion 27 and a body step surface 26, which is a step surface between the body small diameter portion 25 and the body large diameter portion 27, configure a bearing supporting portion 24.

The projection portion 30 projects from the attachment body 21. More specifically, the projection portion 30 projects from a surface in which the body large diameter portion 27 opens, of the opposite surfaces of the attachment body 21. The projection portion 30 has a tubular shape. A center axis of the projection portion 30 is coincident with a center axis of the through-hole 23. An inner circumferential surface of the projection portion 30 includes a projection small diameter portion 35 and a projection large diameter portion 37 that is larger in diameter than the projection small diameter portion 35. The projection small diameter portion 35 and the projection large diameter portion 37 are coincident with each other. In other words, an inner circumferential surface of the projection portion 30 has a stepped shape. Center axes of the projection small diameter portion 35 and the projection large diameter portion 37 are coincident with each other. The projection large diameter portion 37 is located closer to a distal end of the projection portion 30 than the projection small diameter portion 35 is. The diameter of the projection small diameter portion 35 is substantially equal to the inner diameter of the stator body 55. The diameter of the projection large diameter portion 37 is substantially equal to an outer diameter of the stator body 55. The projection large diameter portion 37 and a projection step surface 36, which is a step surface between the projection small diameter portion 35 and the projection large diameter portion 37, configure a stator supporting portion 34.

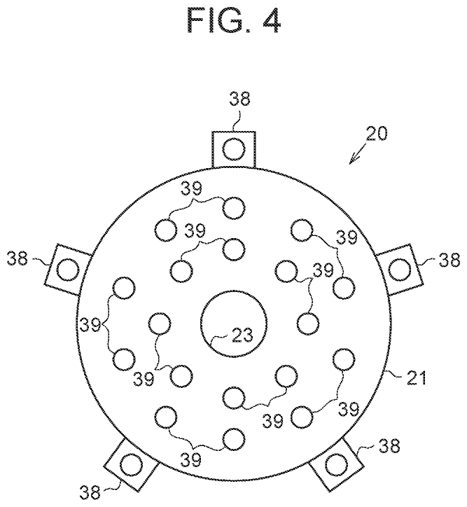

The plurality of bolt holes 39 extend through the attachment body 21. As illustrated in FIG. 4, some of the plurality of bolt holes 39 are located in a part closer to an outer circumference of the attachment body 21. These bolt holes 39 are circumferentially arranged at equal intervals. Also, some of the plurality of bolt holes 39 are located in a part closer to an inner circumference of the attachment body 21. These bolt holes 39 are circumferentially arranged at equal intervals. In FIG. 4, in order to illustrate the bolt holes 39 in a recognizable manner, the bolt holes 39 are enlarged and exaggerated. Also, in FIG. 4, not all of the plurality of bolt holes 39 are illustrated: some of the plurality of bolt holes 39 are skipped.

The plurality of attaching portions 38 project from an outer circumferential surface of the projection portion 30. The plurality of attaching portions 38 are circumferentially arranged at equal intervals. Each attaching portion 38 has a rectangular plate-like shape. Each attaching portion 38 includes an attaching hole extending through the attaching portion 38. In FIG. 4, in order to illustrate the attaching portions 38 in a recognizable manner, the attaching portions 38 are enlarged and exaggerated. Also, in FIG. 3, only one of the plurality of attaching portions 38 is illustrated.

As illustrated in FIG. 3, the case 10 includes a plurality of case attaching portions 13 as structure portions for attaching the attachment 20. The plurality of case attaching portions 13 are located at an end portion of the first case body 12A in a direction along the center axis of the case body 12. The case attaching portions 13 project from an outer circumferential surface of the first case body 12A. The plurality of case attaching portions 13 are circumferentially arranged at equal intervals. Each case attaching portion 13 has a rectangular plate-like shape. Each case attaching portion 13 includes an attaching hole extending through the case attaching portion 13. In FIG. 3, only one of the plurality of case attaching portions 13 is illustrated.

Structure for Attachment of Motor Generator

The motor generator 50 is attached to the attachment 20 configured as described above. The electric vehicle 100 includes a bearing 78 for attaching the connecting shaft 72 to the attachment 20 together with the motor generator 50.

In a state in which attachment 20 is attached to the motor generator 50, the attachment body 21 faces the motor generator 50 in a direction along the center axes of the motor output shaft 52 and the connecting shaft 72. The attachment body 21 is located in the first direction relative to the motor generator 50. The center axis of the through-hole 23 of the attachment body 21 is coincident with the center axes of the motor output shaft 52 and the connecting shaft 72. The projection portion 30 projects toward the motor generator 50. In the words, of the projection small diameter portion 35 and the projection large diameter portion 37, the projection large diameter portion 37 is located closer to the motor generator 50 relative to the projection small diameter portion 35. Likewise, of the body small diameter portion 25 and the body large diameter portion 27 of the through-hole 23, the body large diameter portion 27 is located closer to the motor generator 50 relative to the body small diameter portion 25.

In the disposition of the attachment 20 as above, a part, closer to the attachment 20, of the stator 54, that is, a part on the first direction side of stator 54 is fitted in the stator supporting portion 34 configured by the projection portion 30 of the attachment 20. The stator supporting portion 34 supports the stator 54. In other words, the projection large diameter portion 37 supports an outer circumferential surface of the stator body 55. Also, the projection step surface 36 supports an end surface of the stator body 55.

A plurality of bolts B1 extend through the stator body 55. The bolts B1 extend through the entirety of the stator body 55 in a direction along the center axis of the stator body 55. More specifically, each bolt B1 is inserted through the stator body 55 from the second direction side, which is opposite to the projection step surface 36, toward the first direction side. Each bolt B1 reaches a thick part of the projection portion 30. The bolts B1 fix the attachment 20 and the motor generator 50 to each other in an integrated manner. In FIG. 3, only one of the plurality of bolts B1 is illustrated.

Also, in the above-described disposition of the attachment 20, the connecting shaft 72 extends through the through-hole 23. Then, the bearing 78 is interposed between the inner surface of the through-hole 23 and the connecting shaft 72. The bearing 78 rotatably supports the connecting shaft 72. Although illustration is omitted in FIG. 3, the bearing 78 has a publicly known structure in which a plurality of balls are interposed between an annular outer ring and an annular inner ring. The bearing 78 has a circular ring-like shape overall. The bearing 78 is fitted in the bearing supporting portion 24 configured by the through-hole 23 of the attachment 20. The bearing supporting portion 24 supports the bearing 78. In other words, the body large diameter portion 27 supports an outer circumferential surface of the bearing 78. Also, the body step surface 26 supports an end surface of the outer ring of the bearing 78.

The attachment 20 to which the motor generator 50 is attached is attached to the case body 12 via the plurality of case attaching portions 13. More specifically, in a state in which the attachment 20 is attached to the case body 12, the plurality of attaching portions 38 of the attachment 20 face the plurality of case attaching portions 13. Bolts B2 extend through the respective attaching holes of the attaching portions 38 and the case attaching portions 13 facing each other. The bolts B2 fix the attaching portion 38 and the case attaching portion 13 to each other in an integrated manner.

Auxiliary

The electric vehicle 100 includes a compressor 40. The compressor 40 is an auxiliary that feeds compressed air to an air-conditioning unit of the electric vehicle 100. The compressor 40 includes a compressor case 42, a compressor body 44 and an input shaft 46.

The compressor case 42 includes a case body 42A and a plurality of compressor attaching portions 42B. The case body 42A has a columnar shape in which space is defined inside, overall. The plurality of compressor attaching portions 42B are located at an end portion of the case body 42A in a direction along a center axis of the case body 42A. The compressor attaching portions 42B project from an outer circumferential surface of the case body 42A. The plurality of compressor attaching portions 42B are circumferentially arranged at equal intervals. Each compressor attaching portion 42B has a rectangular plate-like shape.

The compressor body 44 is located inside the case body 42A. The compressor body 44 includes a mechanism that feeds compressed air. The input shaft 46 is connected to the compressor body 44. The input shaft 46 extends in a direction along the center axis of the case body 42A. The input shaft 46 is rotatably supported by the compressor body 44. Upon the input shaft 46 being rotated, the compressor body 44 is driven. The input shaft 46 extends through an end surface of the case body 42A at an end portion of the case body 42A, the end portion being opposite to the end portion at which the compressor attaching portions 42B are located. In other words, a part of the input shaft 46 is located outside the case body 42A.

Like the motor generator 50, the compressor 40 is attached to the case 10 via the attachment 20. The compressor 40 is located in the first direction relative to the attachment 20. In other words, the compressor 40 is located outside the case 10. In a state in which the compressor 40 is attached to the attachment 20, one end surface of the case body 42A of the compressor 40, on the side on which the compressor attaching portions 42B are located, faces the attachment body 21. The plurality of compressor attaching portions 42B face some of the plurality of bolt holes 39 of the attachment 20. Bolts B3 extend through the respective compressor attaching portions 42B. The bolts B3 reach the insides of the bolt holes 39. The bolts B3 fix the compressor attaching portions 42B and the attachment 20 to each other in an integrated manner. In a state in which the compressor 40 is attached to the attachment 20, the input shaft 46 is parallel to the connecting shaft 72.

The electric vehicle 100 includes an endless belt 75. The belt 75 is looped around the connecting shaft 72 and the input shaft 46 of the compressor 40. The belt 75 transmits rotation of the connecting shaft 72 to the input shaft 46.

Hydraulic Pressure Adjustment Mechanism

The electric vehicle 100 includes a hydraulic pressure adjustment mechanism 120 and a control device 130. The hydraulic pressure adjustment mechanism 120 includes a fluid pan 122, a hydraulic pressure circuit 124 and a hydraulic pump 126.

The fluid pan 122 stores the hydraulic fluid. The hydraulic pump 126 is an electrical pump to be driven by a dedicated electric motor that is different from the motor generator 50. The hydraulic pump 126 supplies the hydraulic fluid stored in the fluid pan 122 to the hydraulic pressure circuit 124. The hydraulic pressure circuit 124 is connected to the fluid chamber 67B of the hydraulic clutch 60. The hydraulic pressure circuit 124 includes a solenoid valve 124A. The hydraulic pressure supplied to the fluid chamber 67B is adjusted according to opening or closing of the solenoid valve 124A.

The control device 130 can be configured as one or more processors that perform various types of processing according to a computer program (software). The control device 130 may be configured as one or more dedicated hardware circuits, such as application-specific integrated circuits (ASICs), that perform at least some of various types processing or a circuitry including a combination of such dedicated hardware circuits. The one or more processors each include a CPU and memories such as a RAM and a ROM. The memories store program codes or commands configured to make the CPU perform processing. The memories, that is, computer-readable mediums may be any available mediums that can be accessed by a general-purpose or dedicated computer. The CPU controls the hydraulic pressure adjustment mechanism 120 including the hydraulic pump 126 and the solenoid valve 124A, by executing a program stored on the ROM. By controlling the hydraulic pressure adjustment mechanism 120, the CPU controls hydraulic pressure of the hydraulic fluid to be supplied to the fluid chamber 67B of the hydraulic clutch 60.

In the present embodiment, a drive unit for an electric vehicle includes the motor generator 50, the hydraulic clutch 60, the connecting shaft 72, the compressor 40, the belt 75, the bearing 78, the attachment 20, the case 10, the hydraulic pressure adjustment mechanism 120 and the control device 130.

Method of Attachment of Motor Generator and Compressor

A method of attachment of the motor generator 50 and the compressor 40 to the case 10 will be described.

The motor generator 50 is a reused motor generator originally mounted in another vehicle. The other vehicle is a hybrid vehicle with an internal combustion engine and a motor generator as drive sources. As hybrid vehicles, there are hybrid vehicles of a type including an internal combustion engine and a single motor generator. In this type of hybrid vehicle, a crankshaft, which is an output shaft of an internal combustion engine, is sometimes connected to an output shaft of a motor generator via a clutch. The motor generator in this case incorporates the clutch inside a rotor. The motor generator mounted in the electric vehicle 100 is a motor generator of this type. The connecting shaft 72 connected to the hydraulic clutch 60 is one originally used for connection of the crankshaft of the internal combustion engine. In other words, the clutch is a clutch originally interposed between the output shaft of the motor generator and the crankshaft, the clutch functioning to switch between transmission and non-transmission of torque between the output shaft of the motor generator and the crankshaft.

For attachment of the motor generator 50 and the compressor 40 to the case 10, various necessary components such as the motor generator 50, the compressor 40, the attachment 20 and the case 10 are separately provided in advance. As described above, the motor generator 50 is a reused article from another hybrid vehicle and includes the hydraulic clutch 60 and the connecting shaft 72 in an integrated manner. Also, the case 10 is divided in the first case body 12A and the second case body 12B. The torque converter 82 and the transmission mechanism 86 are housed in the second case body 12B. The first case body 12A and the second case body 12B are not case bodies newly designed for the reused motor generator 50 but case bodies according to a common standard, the case bodies being available for other electric vehicles. Likewise, the attachment 20 is an attachment according to a common standard, the attachment being available for other electric vehicles, and is designed to have dimensions conforming to the case 10.

Attachment work is performed as follows. First, the motor generator 50 is attached to the attachment 20 that is not yet attached to the case body 12. More specifically, the bearing 78 with the connecting shaft 72 inserted is placed in the bearing supporting portion 24 of the attachment 20. Also, the stator 54 of the motor generator 50 is placed in the stator supporting portion 34 of the attachment 20. Then, in this state, the stator 54 is fixed to the attachment 20 via the bolts B1.

Next, the attachment 20 is attached to the case body 12. In other words, the attaching portions 38 of the attachment 20 and the case attaching portions 13 are aligned and fixed to each other via the bolts B2. Subsequently, the first case body 12A and the second case body 12B are joined together after various adjustment works being performed. An example of the adjustment works is work for connecting the motor output shaft 52 and the input shaft of the torque converter 82. Also, another example of the adjustment works is work for connecting the hydraulic pressure circuit 124 to the fluid chamber 67B of the hydraulic clutch 60.

Next, the compressor 40 is attached to the attachment 20. In other words, bolt holes 39 of the attachment 20 and the compressor attaching portions 42B are aligned and fixed to each other via the bolts B3. At this time, from among the plurality of bolt holes 39 provided in the attachment 20, bolt holes 39 located at positions suitable for attachment of the compressor 40 to the attachment 20 are used. The bolt holes 39 to be used can be selected according to a shape and dimensions of the compressor case 42. Also, the bolt holes 39 to be used can be selected in consideration of a position at which the compressor case 42 should be disposed in view of disposition of other components inside the motor compartment 102.

When the compressor 40 is attached to the attachment 20, the belt 75 is looped around the input shaft 46 of the compressor 40 and the connecting shaft 72 in advance in a non-tensed manner. Then, the belt 75 is tensed when attachment of the compressor 40 is completed.

Through the above process, the motor generator 50 and the compressor 40 can be attached to the case 10 via the attachment 20.

### Operation of Embodiment

The control device 130 adjusts the hydraulic pressure in the fluid chamber 67B of the hydraulic clutch 60 through control of the hydraulic pressure adjustment mechanism 120. In response to the adjustment, an operating state of the hydraulic clutch 60 changes. In other words, upon an increase in hydraulic pressure in the fluid chamber 67B of the hydraulic clutch 60, the hydraulic clutch 60 is engaged. In this case, torque is transmitted from the rotor 53 of the motor generator 50 to the connecting shaft 72. The torque transmitted to the connecting shaft 72 is input to the input shaft 46 of the compressor 40 via the belt 75. Upon the input shaft 46 rotating in response to the torque, the compressor body 44 is driven. On the other hand, upon a decrease in hydraulic pressure in the fluid chamber 67B of the hydraulic clutch 60, the hydraulic clutch 60 is disengaged. In this case, no torque is transmitted from the rotor 53 of the motor generator 50 to the connecting shaft 72. In this case, operation of the belt 75 and the input shaft 46 of the compressor 40 stops. Then, the compressor body 44 enters a stop state.

### Effects of Embodiment

(1) Where a motor generator used in another vehicle is reused, the hydraulic clutch 60 and the connecting shaft 72 integrated with the motor generator 50 in an assembly are also reused. In the present embodiment, the motor generator 50 is connected to the compressor 40 via the hydraulic clutch 60 and the connecting shaft 72. Therefore, as described in the Operation of Embodiment section above, it is possible to drive the compressor 40 by transmitting motive power of the motor generator 50 to the compressor 40. In this way, in the present embodiment, the hydraulic clutch 60 and the connecting shaft 72 can be used as components that transmit motive power of the motor generator 50 to the compressor 40. In other words, it is possible to effectively use reused components without any waste.

(2) In the present embodiment, as components for switching the operating state of the hydraulic clutch 60, the hydraulic pressure adjustment mechanism 120 dedicated to the hydraulic clutch 60 and the control device 130 that controls the hydraulic pressure adjustment mechanism 120, which are not linked with operation of the motor generator 50, are provided. Therefore, it is possible to switch the operating state of the hydraulic clutch 60 irrespective of operation of the motor generator 50. Accordingly, it is possible to freely drive or stop the compressor 40 as necessary.

(3) There are a plurality of models of compressors. Then, the compressors differ in shape and dimensions depending on the models. If a compressor that is different in shape and dimensions is used, it is necessary to change a structure to which the compressor is to be attached, according to the shape and the dimensions of the compressor. In other words, depending on the model of the compressor 40 mounted in the electric vehicle 100, the electric vehicle 100 is required to include an attachment structure conformable to the mounted compressor 40.

In order to meet the requirement, it is conceivable to change the structure of the case 10 according to the shape and dimensions of the compressor 40. However, the case 10 occupies quite a large capacity in the motor compartment 102 and has considerably large dimensions. Therefore, a mold for manufacturing the case 10 also has considerably large dimensions. Where the mold has large dimensions, considerable costs are required to modify a shape of the mold or prepare a new mold. Accordingly, a design change of the case 10 cause a considerable increase in cost. Also, there is a restriction on space for receiving the case 10 in the motor compartment 102. From these points, for the case 10, there is a need to use a common case.

Therefore, in the present embodiment, the compressor 40 is attached to the case 10 using the attachment 20. The attachment 20 includes the plurality of bolt holes 39 as a structure for attachment of the compressor 40. Using bolt holes 39 at suitable positions from among the plurality of bolt holes 39 according to the shape and dimensions of the compressor 40 enables properly attaching the compressor 40 to the attachment 20 irrespective of the shape and dimensions of the compressor 40. The present embodiment enables properly attaching a compressor 40 to a case 10 having a shape determined in advance, irrespective of the shape and dimensions of the compressor 40.

Also, a position to which the compressor 40 is to be attached may be restricted in view of disposition of other components inside the motor compartment 102. Even in such case, bolt holes 39 at suitable positions from among the plurality of bolt holes 39 are used to allow the compressor 40 to be disposed at a proper position according to a layout inside the motor compartment 102, enabling attaching the compressor 40 to a case 10 having a shape determined in advance.

(4) In the present embodiment, the connecting shaft 72 and the input shaft 46 of the compressor 40 are linked using the belt 75. Where the connecting shaft 72 and the input shaft 46 are linked using the belt 75, as long as the connecting shaft 72 and the input shaft 46 are disposed in parallel with each other, even if a distance between the connecting shaft 72 and the input shaft 46 changes, the connecting shaft 72 and the input shaft 46 can be linked by adjusting a length of the belt 75. In other words, the configuration of the present embodiment using the belt 75 allows change in position of the compressor 40 under the condition that the connecting shaft 72 and the input shaft 46 are parallel to each other. Therefore, it is possible to dispose the compressor 40 at a necessary position according to the shape and dimensions of the compressor 40 or a requirement for a position for attachment of the compressor 40 due to the layout inside the motor compartment 102 such as those described in (3) above.

(5) In the present embodiment, the compressor 40 is disposed outside the case 10. Therefore, even where a necessity for changing the position for attachment of the compressor 40 arises, work of detaching and attaching the compressor 40 can easily be performed. Therefore, even where a necessity for replacing the compressor 40 with a compressor of a different model or changing disposition of the compressor 40 according to the layout inside the motor compartment 102 arises, work for such replacement or change does not take much trouble.

(6) In the present embodiment, the bearing 78 is supported by the attachment 20. More specifically, an outer circumferential surface of the bearing 78 is supported by the body large diameter portion 27, and an end surface of the bearing 78 is supported by the body step surface 26. Use of such stepped shape enables the bearing 78 to be stably supported. Also, in the present embodiment, the stator 54 of the motor generator 50 is supported by the attachment 20. More specifically, the outer circumferential surface of the stator body 55 is supported by the projection large diameter portion 37 and an end surface of the stator body 55 is supported by the projection step surface 36. Use of such stepped shape enables the stator 54 to be also stably supported. As above, the connecting shaft 72 and the hydraulic clutch 60 are integrated with the motor generator 50. As a result of the bearing 78 supporting the connecting shaft 72, and the stator 54 being both stably supported, the entire motor generator 50 can stably be supported.

As described above, the mold for manufacturing the case 10 is a considerably large-scaled mold. Even if fine structures such as the stepped shapes above are provided at particular positions for supporting the bearing 78 and the stator 54 in such mold, it is difficult to determine the positions accurately. On the other hand, the attachment 20 used in the present embodiment has dimensions enough to connect the motor generator 50 and a wall surface of the case 10. In other words, the dimensions of the attachment 20 are considerably small in comparison with the case 10. A mold for manufacturing such the attachment 20 can be designed with high accuracy even if fine shapes such as the stepped shapes are designed at a particular position. Therefore, in the present embodiment in which supporting structures are provided in the attachment 20, accuracy of positions at which the supporting structures are provided is enhanced. Therefore, it is possible to more stably support the motor generator 50.

Alterations

The present embodiment can be altered as follows. Any combination of the present embodiment and the below alterations is possible as long as such combination causes no technical contradiction.

The procedure for attaching the motor generator 50 and the compressor 40 to the case 10 is not limited to the above example in the embodiment. For example, after the motor generator 50 is attached to the attachment 20, the compressor 40 may be attached to the attachment 20 before attachment of the attachment 20 to the case 10. The attachment 20 may be attached to the case 10 afterward.

The connecting shaft 72 may be divided in, for example, two parts at an intermediate position in a direction along the center axis of the connecting shaft 72. In other words, the connecting shaft 72 may be configured by combining a plurality of components.

The auxiliary connected to the motor generator 50 is not limited to the compressor 40. The auxiliary only needs to be one driven according to rotation of an input shaft. For example, as the auxiliary, a pump for power steering may be employed. A driver's force of operating a steering wheel is assisted according to hydraulic pressure generated by driving the pump.

A plurality of auxiliaries may be attached to the case 10. Use of the plurality of bolt holes 39 in the attachment 20 enables attachment of a plurality of auxiliaries to the attachment 20. In this case, a belt 75 is provided for each auxiliary and positions of the belts 75 are shifted from each other in a direction along the center axis of the connecting shaft 72. It is only necessary that the belts 75 be looped around respective input shafts of the auxiliaries and the connecting shaft 72 in such state. Accordingly, rotation of the connecting shaft 72 can be transmitted to the input shafts of the respective auxiliaries.

The auxiliary may be disposed inside the case 10. Provision of space for disposition of the auxiliary between the attachment 20 and the motor generator 50 enables attachment of the auxiliary to the attachment 20 inside the case 10. In order to provide space for disposition of the auxiliary between the attachment 20 and the motor generator 50, it is only necessary that a position for providing the stator supporting portion 34 be adjusted.

An endless power transmission component linking the input shaft of the auxiliary and the connecting shaft 72 are not limited to the belt 75. For example, as the endless power transmission component, a chain may be employed. In this case, it is only necessary to fix a sprocket to the input shaft of the auxiliary and the connecting shaft 72.

A configuration that links the input shaft of the auxiliary and the connecting shaft 72 is not limited to a configuration using the endless power transmission component. For example, the input shaft of the auxiliary and the connecting shaft 72 may be disposed coaxially and be mechanically linked via, for example, a gear mechanism.

Disposition of the plurality of bolt holes 39 is not limited to the example in the embodiment. For example, the plurality of bolt holes 39 may be arranged irregularly. In order to enable an auxiliary to be attached at any of various positions in the attachment 20, it is preferable that bolt holes 39 be provided at various positions in the attachment 20.

Depending on the model of the motor generator 50 to be reused, dimensions of the motor generator 50 may differ. In this case, for example, it is necessary to change the diameter of the projection large diameter portion 37 included in the stator supporting portion 34, according to the model of the motor generator 50. For such case, for example, a plurality of types of attachments 20 that are different from one another in diameter of the projection large diameter portion 37 may be provided in advance and a proper one may be selected from the plurality of types of attachments 20.

The configuration of the stator supporting portion 34 is not limited to the example in the above embodiment. For example, the stepped shape at the inner circumferential surface of the projection portion 30 may be eliminated and an inner diameter of the projection portion 30 may be made constant over an entire length of the projection portion 30. Then, the stator supporting portion 34 may be configured by the inner circumferential surface of the projection portion alone. In this case, for example, the stator body 55 being pressed onto the inner circumferential surface of the projection portion 30 enables stably supporting the stator 54.

It is not essential to provide a structure that supports the stator 54 at the attachment 20. For example, if it is possible to support the stator 54 using an existing structure in the case 10, there is no need to support the stator 54 via the attachment 20.

The configuration of the bearing supporting portion 24 is not limited to the example in the above embodiment. Like the aforementioned alteration of the stator supporting portion 34, for example, the stepped shape at the inner surface of the through-hole 23 may be eliminated and a diameter of the through-hole 23 may be made constant over an entire length of the through-hole 23.

Like the alteration of the structure that supports the stator 54, it is not essential to provide a structure that supports the bearing 78 at the attachment 20. The structure for attaching the auxiliary to the attachment 20 is not limited to the structure using the bolt holes 39. For example, as the structure for attaching the auxiliary to the attachment 20, a recess or a projection may be provided in the attachment. Then, the auxiliary may be fitted to or pressed into the recess or the projection.

The auxiliary may be attached to the case 10 without using the attachment 20. If the auxiliary can be attached to the case 10 using an existing structure in the case 10, there is no need to use the attachment 20.

If the attachment 20 is not used to attach the auxiliary, the motor generator 50 and the bearing 78 to the case 10, the attachment 20 may be eliminated.

A mechanism that adjusts the hydraulic pressure in the fluid chamber 67B of the hydraulic clutch 60 is not limited to the example in the above embodiment. For example, the hydraulic pressure in the fluid chamber 67B of the hydraulic clutch 60 may be adjusted using motive power of the motor generator 50. In this case, the operating state of the hydraulic clutch 60 switches in coordination with operations of the motor generator 50 such as rotation and stoppage of the rotor 53. Where an auxiliary requiring a driving state to be switched in coordination with operation of the motor generator 50 is connected, it is possible to drive the auxiliary at a proper timing even if the above method is employed for the mechanism that adjusts the hydraulic pressure in the fluid chamber 67B.

The material of the case 10 is not limited to the example in the above embodiment. For the material of the case 10, a material that is proper for receiving the components of the drive mechanism 18 only needs to be employed. In consideration of weight of the components of the drive mechanism 18, it is preferable that the material be a material having adequate stiffness. Also, in consideration of the components of the drive mechanism 18 generating heat, it is preferable that the material be excellent in heat dissipation performance.

The material of the attachment 20 is not limited to the example in the above embodiment. For the material of the attachment 20, a material that is proper for attaching the motor generator 50 to the case body 12 only needs to be employed. Like the alteration relating to the material of the case 10, a proper material that is suitable in the perspective of, for example, stiffness and heat dissipation performance only needs to be employed. Also, the material of the attachment 20 may be the same as or different from the material of the case 10. The attachment 20 is a part of a heat transmission passage from the motor generator 50 to the case 10. From such perspective, it is preferable that the material of the attachment 20 be a material having a thermal conduction efficiency that is equal to or exceeds a thermal conduction efficiency of the case 10.

What is claimed is:

1. A drive unit for an electric vehicle, the drive unit comprising:
a motor including a tubular rotor, a stator located radially outward of the rotor as viewed from a center axis of the rotor, and an output shaft that rotates integrally with the rotor and that transmits a drive force of the rotor to a drive wheel;
a connecting shaft capable of rotating coaxially with the output shaft;
a hydraulic clutch interposed between the rotor and the connecting shaft, the hydraulic clutch switching between transmission and non-transmission of torque between the rotor and the connecting shaft; and
an auxiliary including an input shaft, the auxiliary being driven by rotation of the input shaft,
wherein the input shaft is mechanically linked with the connecting shaft such that torque from the rotor can be input to the input shaft.

2. The drive unit for an electric vehicle according to claim 1, the drive unit comprising:
a hydraulic pump that supplies a hydraulic fluid to the hydraulic clutch; and
a control device that controls hydraulic pressure of the hydraulic fluid supplied from the hydraulic pump to the hydraulic clutch.

3. The drive unit for an electric vehicle according to claim 1, the drive unit comprising, where a first direction is a direction in which the connecting shaft is located as viewed from the motor, of directions along the center axis of the rotor,
a case that receives the motor, the connecting shaft and the hydraulic clutch, and
an attachment that is located in the first direction as viewed from the motor, and that is attached to the case, wherein
the attachment includes a plurality of bolt holes, and
the auxiliary is connected to the attachment via a bolt inserted in a bolt hole selected form the plurality of bolt holes.

4. The drive unit for an electric vehicle according to claim 3, wherein:
the auxiliary is located in the first direction as viewed from the attachment and is located outside the case;
the connecting shaft extends through the attachment;
the input shaft is disposed in parallel with the connecting shaft; and
an endless power transmission component located outside the case and looped around the input shaft and the connecting shaft is provided.

5. The drive unit for an electric vehicle according to claim 4, wherein:
the attachment includes a through-hole through which the connecting shaft extends; and
a bearing that rotatably supports the connecting shaft is located inside the through-hole.
